(19) United States
(12) Patent Application Publication
(10) Pub. No.: US 2026/0213084 A1
(43) Pub. Date: Jul. 23, 2026

(54) SOLID ELECTROLYTIC CAPACITOR

(71) Applicant: Panasonic Intellectual Property Management Co., Ltd., Kadoma-shi, Osaka (JP)

(72) Inventors: Masahiro Ueda, SAGA KEN (JP); Takashi Umemoto, OSAKA FU (JP)

(73) Assignee: Panasonic Intellectual Property Management Co., Ltd., Kadoma-shi, Osaka (JP)

(21) Appl. No.: 19/142,333

(22) PCT Filed: Dec. 21, 2023
(86) PCT No.: PCT/JP2023/046024

§ 371 Date: Jun. 23, 2025

(30) Foreign Application Priority Data
Dec. 26, 2022 (JP) 2022-208703

(51) Int. Cl. H01G 9/15

(52) U.S. Cl. CPC H01G 9/15

(57) ABSTRACT

A solid electrolytic capacitor includes at least one capacitor element. The capacitor element includes an anode body, a dielectric layer covering at least part of the anode body, and a solid electrolyte covering at least part of the dielectric layer. The rated voltage of the solid electrolytic capacitor is Rv (unit: V). A maximum current value Iₘ (unit: mA) that flows when a voltage is applied at 25° C.±5° C. after the solid electrolytic capacitor is dried at 170° C. for 3 hours, to raise the voltage of the solid electrolytic capacitor from 0 V to Rv in a time of 30±5 msec., and a current value Iᵢ (unit: mA) 5 msec. after the start of the voltage application satisfy Iₘ/Iᵢ≤10.

### TECHNICAL FIELD

The present disclosure relates to a solid electrolytic capacitor.

### BACKGROUND ART

A solid electrolytic capacitor includes, for example, a solid electrolytic capacitor element, and a resin package body or case encapsulating the solid electrolytic capacitor element. The solid electrolytic capacitor element has, for example, an anode body, a dielectric layer formed on the surface of the anode body, and a cathode section covering at least part of the dielectric layer. The cathode section includes a conductive polymer (e.g., a conjugated polymer and dopant) covering at least part of the dielectric layer. The conductive polymer is sometimes referred to as a solid electrolyte.

Patent Literature 1 proposes a solid electrolytic capacitor comprising: a sintered porous anode body having an exterior surface that spans in a longitudinal direction so as to define a length of the anode body, in which at least one channel is recessed into the exterior surface of the anode body, the channel is defined by opposing sidewalls that intersect with a base, the channel has a width of about 0.4 millimeters to about 3 millimeters and a depth of about 50 micrometers to about 350 micrometers; a dielectric overlapping with the anode body; and a solid electrolyte overlapping with the dielectric and containing conductive polymer particles.

### CITATION LIST

### Patent Literature

Patent Literature 1: Japanese Laid-Open Patent Publication No. 2022-533162

### SUMMARY OF INVENTION

### Technical Problem

A solid electrolytic capacitor is often used by being connected to an electronic circuit. However, the solid electrolytic capacitor, in some cases, may cause the electronic circuit to malfunction.

### Solution to Problem

One aspect of the present disclosure relates to a solid electrolytic capacitor, including at least one capacitor element, wherein
the capacitor element includes an anode body, a dielectric layer covering at least part of the anode body, and a solid electrolyte covering at least part of the dielectric layer,
a rated voltage of the solid electrolytic capacitor is Rv (unit: V), and
a maximum current value Iₘ (unit: mA) that flows when a voltage is applied at 25° C.±5° C. after the solid electrolytic capacitor is dried at 170° C. for 3 hours, to raise a voltage of the solid electrolytic capacitor from 0 V to Rv in a time of 30±5 msec., and a current value Iᵢ (unit: mA) 5 msec. after a start of the voltage application satisfy Iₘ/Iᵢ≤10.

Another aspect of the present disclosure relates to a solid electrolytic capacitor, including at least one capacitor element, wherein
the capacitor element includes an anode body, a dielectric layer covering at least part of the anode body, and a solid electrolyte covering at least part of the dielectric layer,
a rated voltage of the solid electrolytic capacitor is Rv (unit: V), and
a leakage current value Iₙ that flows 10 msec. after the rated voltage Rv is applied at 25° C.±5° C. after the solid electrolytic capacitor is dried at 170° C. for 3 hours is 100 mA or less.

### Advantageous Effects of Invention

It is possible to suppress the malfunction of the electronic circuit to which the solid electrolytic capacitor is connected.

### BRIEF DESCRIPTION OF DRAWINGS

FIG. 1 A schematic sectional view of a solid electrolytic capacitor according to one embodiment of the present disclosure.

FIG. 2 A graph showing changes of leakage current with changes over time during voltage application in a solid electrolytic capacitor of Example 1.

FIG. 3 A graph showing changes of leakage current with changes over time during voltage application in a solid electrolytic capacitor of Comparative Example 1.

FIG. 4 A graph showing the relationship between a leakage current value Iₚ (mA) and an anomalous charging current (mA) that flows under predetermined conditions in solid electrolytic capacitors of Examples 1 to 4.

### DESCRIPTION OF EMBODIMENTS

While the novel features of the invention are set forth particularly in the appended claims, the invention, both as to organization and content, will be better understood and appreciated, along with other objects and features thereof, from the following detailed description taken in conjunction with the drawings.

When a solid electrolytic capacitor is used by being connected to an electronic circuit, depending on the environment in which it is used, the solid electrolytic capacitor may cause the electronic circuit to malfunction in some cases. At times, an emergency stop of the electronic circuit occurs. The malfunction of the electronic circuit is often due to the leakage current of the solid electrolytic capacitor. It has been revealed, however, that even though the leakage current is small in the stage after a relatively long time like 5 minutes or 10 minutes from the start of charging, posing little problem, there is a case where the malfunction of the electronic circuit occurs. Moreover, although such a malfunction of the electronic circuit poses little problem when the solid electrolytic capacitor is in a moisture-absorbed state, it becomes particularly noticeable when in a dry state. In other words, the solid electrolytic capacitor according to the present disclosure is assumed to be used, for example, in an application where it is connected to a DC power source and charged with a direct current for at least 5 minutes or more or 10 minutes or more, rather than used by being connected to an AC power source. An example of such an application is a backup power source, such as SSD. The assumed rated capacitance is, for example, 6.8 μF or more, but is not particularly limited. The assumed rated charging voltage is, for example, 16 V or more, but is not particularly limited.

In view of the above, (Technique 1) a solid electrolytic capacitor according to one aspect of the present disclosure includes at least one capacitor element. The capacitor element includes an anode body, a dielectric layer covering at least part of the anode body, and a solid electrolyte covering at least part of the dielectric layer. A rated voltage of the solid electrolytic capacitor is Rv (unit: V). A maximum current value Iₘ (unit: mA) that flows when a voltage is applied after the solid electrolytic capacitor is dried at 170° C. for 3 hours, to raise a voltage of the solid electrolytic capacitor from 0 V to Rv in a time of 30±5 msec., and a current value Iᵢ (unit: mA) 5 msec. after a start of the voltage application satisfy Iₘ/Iᵢ≤10.

According to the solid electrolytic capacitor of the above (Technique 1), by satisfying Iₘ/Iᵢ≤10 when a voltage is applied under specific conditions after the above drying, it is possible to prevent a malfunction of the electronic circuit. This is presumably because a large leakage current (anomalous charging current: ACC) flows into the solid electrolytic capacitor in the stage after a very short time from the start of the voltage application to the solid electrolytic capacitor, and along with this, the flowing of large current into the electronic circuit is suppressed.

(Technique 2) In the above (Technique 1), a rated capacity of the solid electrolytic capacitor is Rc (unit: μF), and the maximum current value Iₘ may satisfy a following inequation (I):

$${I}_{m} \leq 0.176 \times ( Rv \times Rc ) - 90. \qquad ( I )$$

When the maximum current value Iₘ satisfies the inequation (I), depending on at least one of the rated voltage and the rated capacity of the solid electrolytic capacitor, the malfunction of the electronic circuit to which the solid electrolytic capacitor is connected can be suppressed.

The right side of the inequation (I) is empirically determined, in a plurality of solid electrolytic capacitors that satisfy Iₘ/Iᵢ≤10 when a voltage is applied under specific conditions after the above drying, on the basis of a plotted graph of the value obtained by multiplying the rated voltage (V) by the rated capacity (F) which is taken as “x” and the value of the ACC (mA) which is taken as “y”. The higher the rated capacity Rc of the solid electrolytic capacitor is, the higher the increase percentage of the rated voltage Rv is, and also, the higher the allowable maximum current value Iₘ is. However, when the maximum current value Iₘ satisfies the inequation (I), the malfunction of the electronic circuit to which the solid electrolytic capacitor is connected is more remarkably ameliorated. More specifically, the right side of the inequation (I) is obtained by the following procedure. First, three types of solid electrolytic capacitors which satisfy Iₘ/Iᵢ≤10 and in which the values of x=Rv×Rc are 1645 μFV, 2000 μFV, and 2400 μFV, respectively, are prepared. A plurality of (e.g., 10 or more) solid electrolytic capacitors are prepared for each type. The solid electrolytic capacitors are dried at 170° C. for 3 hours, cooled to 25° C.±5° C. under drying conditions, and in the air, the rated voltage Rv is applied at 25° C.±5° C., to measure the ACC (unit: mA) of the solid electrolytic capacitors. An average value (=x) is calculated for each of the three types of solid electrolytic capacitors. In the present specification, the ACC is measured every 2 sec. using an oscilloscope TDS7054 available from Tektronix Inc. An average value of the obtained ACCs is determined as “y”. Then, the values of x and y are plotted and linearly approximated using a commercially available calculation software (e.g., Microsoft Excel). Thus, the right side of the inequation (I) can be obtained.

(Technique 3) In the above (Technique 1) or (Technique 2), the maximum current value Iₘ and the current value Iᵢ may satisfy Iₘ/Iᵢ≤3. In this case, the leakage current in the stage after a very short time from the start of the voltage application to the solid electrolytic capacitor can be further reduced. Therefore, the malfunction of the electronic circuit to which the solid electrolytic capacitor is connected can be further suppressed.

(Technique 4) A solid electrolytic capacitor according to another aspect of the present disclosure includes at least one capacitor element. The capacitor element includes an anode body, a dielectric layer covering at least part of the anode body, and a solid electrolyte covering at least part of the dielectric layer. A rated voltage of the solid electrolytic capacitor is Rv (unit: V). A leakage current value Iₙ that flows 10 msec. after the rated voltage Rv is applied at 25° C.±5° C. after the solid electrolytic capacitor is dried at 170° C. for 3 hours is 100 mA or less. Since the leakage current value after a very short time from the start of the application of the rated voltage Rv to charge the solid electrolytic capacitor is small, the malfunction of the electronic circuit to which the solid electrolytic capacitor is connected can be further suppressed. Note that the feature of (Technology 4) may be satisfied in any one of the above (Technology 1) to (Technology 3).

(Technique 5) In any one of the above (Technique 1) to (Technique 4), when a leakage current value Ip (unit: mA) that flows 1.3 msec. after the rated voltage Rv is applied at 25° C.±5° C. after the solid electrolytic capacitor is dried at 170° C. for 3 hours is plotted against an anomalous charging current (ACC, unit: mA), the leakage current value Iₚ and the ACC can be approximated by a linear expression. This means that, as a result of controlling the leakage current value Iₚ and the ACC, the maximum current value Iₘ of the solid electrolytic capacitor is controlled to a low level, and the malfunction of the connected electronic circuit can be further suppressed.

(Technique 6) In the above (Technique 5), a determination coefficient R² of the linear expression may be 0.9 or more. The determination coefficient R² represents the degree of deviation between the plotted actual values and the approximated linear expression, and can take a value in the range of 0 to 1. In the present disclosure, the determination coefficient R² of the linear expression is high, which means that the linear expression is excellent in reliability (or linearity). Therefore, the correlation between the leakage current value Iₚ and ACC is high, the maximum current value Iₘ of the solid electrolytic capacitor is controlled with high accuracy, and the malfunction of an electronic circuit to be connected can be further suppressed.

The above linear expression can be obtained by the following procedure. First, plural types (4 types or more) of solid electrolytic capacitors that satisfy at least one of (Technology 1) to (Technology 4) are prepared. For each type, a plurality of (e.g., 10 or more) solid electrolytic capacitors are prepared. After the solid electrolytic capacitors are dried at 170° C. for 3 hours and then cooled to 25° C.±5° C. under drying conditions, the rated voltage Rv is applied at 25° C.±5° C. in the air, to measure the ACC (unit: mA) of the solid electrolytic capacitors, and an average value (=y) is calculated for each of the plural types (4 types or more) of solid electrolytic capacitors. Also, after the solid electrolytic capacitors are dried at 170° C. for 3 hours and then cooled to 25° C.±5° C. under drying conditions, the rated voltage Rv is applied at 25° C.±5° C. in the air to the solid electrolytic capacitors, to measure a leakage current value 1.3 msec after the start of the application of the rated voltage Rv, and an average value Iₚ (=x) is calculated for each of the plural types (four or more types) of solid electrolytic capacitors. Then, the values of x and y are plotted to create a graph. The plotted calculated values are linearly approximated using a commercially available calculation software (e.g., Microsoft Excel). In this way, a linear expression and a determination coefficient R² can be obtained. Each of the plural types of solid electrolytic capacitors are produced by changing the cleaning conditions of the anode body with the solid electrolyte formed thereon or of the anode body with the dielectric layer formed thereon, or other conditions, as described later.

The solid electrolytic capacitor of the present disclosure will be described more specifically below, including the above (Technology 1) to (Technology 6). At least one selected from the components described below can be combined in any combination with at least one of the above (Technology 1) to (Technology 6) according to the solid electrolytic capacitor of the present disclosure, as long as such combination is technically possible.

### [Solid Electrolytic Capacitor]

In a solid electrolytic capacitor according to one aspect of the present disclosure, a maximum current value Iₘ (mA) that flows when a voltage is applied after the solid electrolytic capacitor is dried at 170° C. for 3 hours, to raise the voltage of the solid electrolytic capacitor from 0 V to Rv in a time of 30±5 msec., and a current value Iᵢ (mA) 5 msec. after the start of the voltage application satisfy Iₘ/Iᵢ≤10. In this case, the leakage current value after a very short time from the start of the voltage application is reduced, and an unintentional flowing of a large current into the electronic circuit to which the solid electrolytic capacitor is connected is suppressed, and thus, the malfunction of the electronic circuit can be suppressed. In view of further suppressing the malfunction of the electronic circuit, the solid electrolytic capacitor preferably satisfies Iₘ/Iᵢ≤5, and more preferable satisfies Iₘ/Iᵢ≤3 or Iₘ/Iᵢ≤2. The application of voltage and the measurement of the current value are performed at 25° C.±5° C., after drying as above and then cooling to 25° C.±5° C. under drying conditions.

The maximum current value Iₘ may satisfy the following inequation (I):

$${I}_{m} \leq 0.176 \times ( Rv \times Rc ) - 90. \qquad ( I )$$

Here, the Rc is a rated capacity (unit: μF) of the solid electrolytic capacitor. When the maximum current value Iₘ satisfies the inequation (I), the malfunction of the electronic circuit can be suppressed, depending on at least one of the rated voltage and the rated capacity of the solid electrolytic capacitor.

In a solid electrolytic capacitor according to another aspect of the present disclosure, a leakage current value Iₙ that flows 10 msec. after the rated voltage Rv is applied after the solid electrolytic capacitor is dried at 170° C. for 3 hours may be 100 mA or less, and may be 50 mA or less. Since the leakage current value after a very short time from the start of the voltage application can be suppressed low, the malfunction of the electronic circuit can be further suppressed. The application of voltage and the measurement of the leakage current value are performed at 25° C.±5° C., after drying as above and then cooling to 25° C.±5° C. under drying conditions.

In the solid electrolytic capacitor according to the present disclosure, when the leakage current value Iₚ (mA) that flows 1.3 msec. after the rated voltage Rv is applied after the solid electrolytic capacitor is dried at 170° C. for 3 hours is plotted against the ACC (mA), the leakage current value Iₚ and the ACC can be approximated by a linear expression. In this case, the maximum current value Iₘ can be controlled to a low level, and the malfunction of the connected electronic circuit can be further suppressed. The application of voltage and the measurement of the leakage current value are performed at 25° C.±5° C., after drying as above and then cooling to 25° C.±5° C. under drying conditions.

The determination coefficient R² that indicates the reliability of the above linear expression may be 0.9 or more. The linear expression has a small deviation from the measured value, and the maximum current value Iₘ can be controlled with high accuracy. Therefore, the malfunction of the electronic circuit can be further reduced. The determination coefficient R² is 1.0 or less.

The solid electrolytic capacitor of the present disclosure is formed by, for example, washing an anode body with a solid electrolyte formed thereon or an anode body with a dielectric layer formed thereon, using a washing liquid. When washing an anode body with a dielectric layer formed thereon, for example, the anode body taken out from the chemical conversion solution may be washed as it is, or the anode body taken out from the chemical conversion solution may be dried and then washed. When washing an anode body with a solid electrolyte formed thereon, usually, a liquid composition for forming a solid electrolyte is attached to an anode body having a dielectric layer, followed by drying and, then, washing. The washed anode body is usually subjected to a drying treatment. The drying treatment is performed, for example, at a temperature of 60° C. or higher and 150° C. or lower for a duration of 5 minutes or more and 60 minutes or less.

As the washing liquid, a washing liquid containing at least an organic solvent is used. The washing liquid may be a mixed solution of an organic solvent and an acidic aqueous solution. The organic solvent may be an organic solvent or an organic dispersion medium contained in a liquid composition for forming a solid electrolyte. Examples of the organic solvent include alcohols (ethanol etc.), ketones (acetone, ethyl methyl ketone, etc.), nitriles (acetonitrile etc.), esters (ethyl acetate etc.), ethers (diethyl ether, tetrahydrofuran, etc.), amides (dimethylformamide, N-methylpyrrolidone, etc.), and sulfoxides (dimethyl sulfoxide etc.). The washing liquid may contain these organic solvents singly or in combination of two or more kinds. Examples of the acidic aqueous solution include an aqueous sulfuric acid solution, an aqueous hydrochloric acid solution, an aqueous nitric acid solution, and an aqueous phosphoric acid solution. The acidic aqueous solution may be used singly or in combination of two or more kinds. The concentration of the acid in the washing liquid may be 1 mass % or more and 30 mass % or less.

The components of the solid electrolytic capacitor will be more specifically described below.

The solid electrolytic capacitor includes at least one capacitor element. The solid electrolytic capacitor may include two or more capacitor elements.

### (Capacitor Element)

The capacitor element includes an anode body, a dielectric layer covering at least part of the anode body, and a solid electrolyte covering at least part of the dielectric layer. The solid electrolyte constitutes at least part of a cathode section covering at least part of the dielectric layer.

### (Anode Body)

The anode body may contain, for example, a valve metal, an alloy containing a valve metal, and a compound containing a valve metal (an intermetallic compound etc.). These materials may be used singly or in combination of two or more kinds. Examples of the valve metal include aluminum, tantalum, niobium, and titanium.

The anode body may be a foil (anode foil) of a valve metal, an alloy containing a valve metal, or a compound containing a valve metal, and may be a molded body (porous molded body) of particles of a valve metal, an alloy containing a valve metal, or a compound containing a valve metal, or a sintered body (porous sintered body) thereof.

The anode body is divided, for example, into an anode-leading part and a cathode-forming part. On the surface of the cathode-forming part of the anode body, a cathode section containing a solid electrolyte is formed. The anode-leading part is, for example, used for electrical connection with an external electrode on the anode side. To the anode-leading part, an anode lead terminal may be connected. In a porous molded body or a porous sintered body, the anode body may be combined with an anode lead (anode wire etc.) to constitute an anode section. A portion of the anode lead may protrude outward the solid electrolytic capacitor from one end face of the anode body. The remaining portion of such an anode lead is usually embedded in the anode body.

The anode body may have a porous portion at least in the surface layer. The porous portions contain many microscopic voids. With the porous portion, the anode body can have fine irregularities on at least its surface and, thus, have increased surface area, which leads to high capacity. The porous portions may be formed in part of the surface layer of the anode body or in the entire surface layer. When the anode body is an anode foil, the porous portion may be formed in, for example, at least the surface layer of the cathode-forming part, and may be formed in at least part of the surface layer of the anode-leading part, in addition to the surface layer of the cathode-forming part. When the anode body is a porous molded body or a porous sintered body, the whole anode body may constitute the porous portion.

When the anode body is an anode foil, the porous portion is formed by roughening the surface of at least a portion corresponding to the cathode-forming part of a base material (e.g., metal foil) containing a valve metal. The roughening may be performed by etching treatment or the like. The etching treatment may be performed by electrolytic etching or chemical etching.

### (Dielectric Layer)

The dielectric layer is an insulating layer that functions as a dielectric. The dielectric layer is formed by anodizing the valve metal at the surface of the anode body by chemical conversion treatment or the like. In the dielectric layer formed at the surface of an anode foil having a porous portion, the surface of the dielectric layer has fine irregularities according to the shape of the surface of the porous portion.

The dielectric layer may be formed from a material that functions as a dielectric layer. The dielectric layer includes, as such a material, for example, an oxide of a valve metal. For example, when tantalum is used as the valve metal, the dielectric layer contains Ta₂O₅, and when aluminum is used as the valve metal, the dielectric layer contains Al₂O₃. The dielectric layer, however, is not limited to these specific examples.

### (Cathode Section)

The cathode section includes at least a solid electrolyte covering at least part of the dielectric layer. The solid electrolyte is formed at the cathode-forming part of the anode body, with the dielectric layer therebetween. The cathode section usually includes a solid electrolyte covering at least part of the dielectric layer, and a cathode-leading layer covering at least part of the solid electrolyte. The solid electrolyte may cover the dielectric layer, in a layer form. The solid electrolyte and the cathode leading layer will be described below.

### (Solid Electrolyte)

The solid electrolyte is not particularly limited, and a solid electrolyte used in any known electrolytic capacitor may be adopted. The solid electrolyte may be a laminate of two or more different solid electrolytes.

The solid electrolyte is disposed so as to cover at least part of the dielectric layer. The solid electrolyte may be formed using, for example, at least one of a manganese compound and a conductive polymer. The conductive polymer includes, for example, a conjugated polymer and a dopant. The conductive polymer may include a self-doped conductive polymer.

Examples of the conjugated polymer include polypyrrole, polythiophene, polyaniline, and derivatives thereof. These may be used singly or in combination of two or more kinds. The conjugated polymer may be a copolymer of two or more kinds of monomers. A derivative of a conjugated polymer means a polymer whose backbone is a conjugated polymer. Examples of the derivative of polythiophene include poly(3,4-ethylenedioxythiophene).

The dopant can be selected depending on the conjugated polymer, and a known dopant may be used. Examples of the dopant include a compound capable of generating anions (e.g., aromatic sulfonic acid, such as naphthalenesulfonic acid and p-toluenesulfonic acid, or salts thereof), and a polyanion (e.g., polymer-type polyanion, such as polystyrene sulfonic acid). Examples of the solid electrolyte include a polypyrrole doped with aromatic sulfonic acid, and poly(3,4-ethylenedioxythiophene) (PEDOT) doped with polystyrenesulfonic acid (PSS).

The solid electrolyte may be formed, for example, on the dielectric layer, by polymerizing a precursor (raw monomer etc.) of a conjugated polymer, in the presence of a dopant as necessary. The solid electrolyte may be formed by applying a liquid composition containing the conjugated polymer (and a dopant, as necessary) onto the dielectric layer, followed by drying.

### (Cathode-Leading Layer)

The cathode-lading layer is a conductive layer. The cathode-leading layer is disposed so as to cover at least part of the solid electrolyte. The configuration of the cathode-leading layer is not particularly limited, and any known cathode-leading layer may be adopted. The cathode-leading layer may include, for example, a carbon layer formed on the solid electrolyte layer, and a metal particle-containing layer formed on the carbon layer. The carbon layer may contain a conductive carbon material, such as graphite, and a resin. The metal particle-containing layer may contain metal particles (e.g., silver particles) and a resin. The metal particle-containing layer may be a silver particle-containing layer formed from a silver paste containing silver particles or silver alloy particles.

The cathode-leading layer may include a metal foil. For the metal foil, a valve metal (aluminum, tantalum, niobium, etc.) or an alloy containing a valve metal may be used. The surface of the metal foil may be roughened, as necessary. The metal foil may be provided at its surface with a chemical conversion film, or with a surface film of a metal different from the metal constituting the metal foil (i.e., a dissimilar metal) or of a non-metal. Examples of the dissimilar metal and the non-metal include a metal such as titanium, and a non-metal such as carbon (conductive carbon etc.).

### Others

The solid electrolytic capacitor may be of a wound type, and may be a chip type or a laminated type. For example, the solid electrolytic capacitor may include a plurality of capacitor elements laminated together. Also, the solid electrolytic capacitor may include two or more wound capacitor elements. The configuration of the capacitor element may be selected depending on the type of the solid electrolytic capacitor. When a metal foil is used as the cathode-leading layer, a separator may be disposed between the metal foil and the anode body (anode foil etc.).

In the capacitor element, to the cathode-leading layer, one end of a cathode terminal may be electrically connected. The cathode terminal is joined to the cathode-leading layer, for example, via a conductive adhesive applied onto the cathode-leading layer. To the anode-leading part of the anode body, one end of an anode terminal may be electrically connected. The other end of the anode terminal and the other end of the cathode terminal are each drawn out from the resin package body or case. The other end of each terminal exposed from the resin package body or case is used for solder connection or the like to the substrate on which the solid electrolytic capacitor is to be mounted. Not limited to the case where the lead terminals are drawn out, the end face of at least one of the anode and cathode sections may be exposed from the outer surface of the sealing body and electrically connected to an external electrode.

The capacitor element is encapsulated using a resin package body or case. For example, the capacitor element and a material resin (e.g., an uncured thermosetting resin and a filler) of the package body may be placed in a mold, which are then subjected to transfer molding, compression molding, or the like, to encapsulate the capacitor element with a resin package body. At this time, a portion on the other end side of the anode terminal connected to an anode lead drawn out from the capacitor element, and a portion on the other end side of the cathode terminal are exposed from the mold. The solid electrolytic capacitor may be formed by placing the capacitor element in a bottomed case such that the portion on the other end side of the anode terminal and the portion on the other end side of the cathode terminal are positioned on the opening side of the bottomed case, and sealing the opening of the bottomed case with a sealing body.

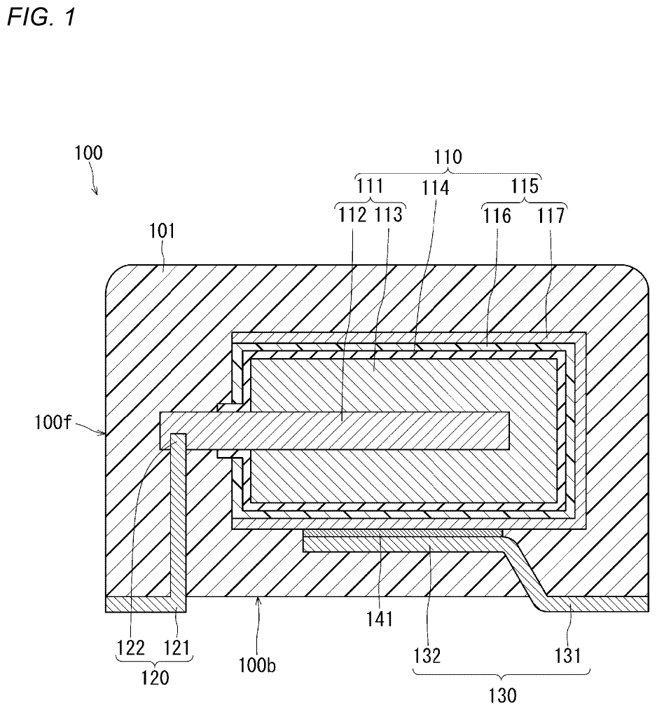

FIG. 1 is a schematic sectional view illustrating an example of the solid electrolytic capacitor according to the present disclosure. A solid electrolytic capacitor 100 illustrated in FIG. 1 includes a capacitor element 110, an anode lead terminal 120, a cathode lead terminal 130, a package body 101, and a conductive layer 141. The capacitor element 110 includes an anode section 111, a dielectric layer 114, and a cathode section 115. The anode section 111 includes an anode body 113 and an anode lead (anode wire) 112. The anode body 113 is a rectangular parallelepiped-shaped porous sintered body, with a dielectric layer 114 formed on its surface. A portion of the anode lead 112 protrudes from one end face of the anode body 113 toward a front face 100f of the solid electrolytic capacitor 100. The other portion of the anode lead is embedded in the anode body 113.

The cathode section 115 includes a solid electrolyte layer 116 disposed so as to cover at least part of the dielectric layer 114, and a cathode-leading layer 117 formed on the solid electrolyte layer 116. The cathode-leading layer 117 includes, for example, a carbon layer formed on the solid electrolyte layer 116, and a metal particle-containing layer formed on the carbon layer. The metal particle-containing layer is formed, for example, using a metal paste (silver paste etc.).

The anode lead terminal 120 includes an anode terminal portion 121 and a lead connection portion 122. The anode terminal portion 121 is exposed at a bottom face 100b of the solid electrolytic capacitor 100. The lead connection portion 122 is connected to the anode lead 112. The cathode lead terminal 130 includes a cathode terminal portion 131 and a connection portion 132. The cathode terminal portion 131 is exposed at the bottom face 100b of the solid electrolytic capacitor 100. The connection portion 132 is electrically connected to the cathode-leading layer 117 via the conductive layer 141.

While the above describes a case of using a porous sintered body as the anode body, the present disclosure may be applied to a laminated or wound solid electrolytic capacitor using an anode foil. The wound electrolytic capacitor includes an electrode plate group, a solid electrolyte, and a case. The electrode plate group includes a wound body, an anode lead, and a cathode lead. The wound body is formed by winding a metal foil (anode foil) serving as the anode body, a separator, and a cathode foil. The anode lead is connected to the anode foil, and the cathode lead is connected to the cathode foil. The anode body is formed from a metal containing a valve metal. The surface of the anode body is roughened or made porous, and a dielectric layer is formed on that surface. The separator is impregnated with a solid electrolyte. The wound electrolytic capacitor may contain a liquid, such as an electrolyte solution. These components are not particularly limited, and any known components used in wound electrolytic capacitors may be used.

### EXAMPLES

The present invention will be specifically described below with reference to Examples and Comparative Examples. The present invention, however, is not limited to the following Examples.

### Example 1

### (1) Production of Capacitor Element

### (i) Preparation of Anode Body

A Ta powder was used as a valve metal. The Ta powder was molded into a rectangular parallelepiped such that one end of a wire-shaped anode lead made of Ta was embedded in the Ta powder, and then, the molded body was sintered in a vacuum. Thus, an anode section including a porous sintered body of Ta and an anode lead was obtained, with a portion of the anode lead embedded in the porous sintered body, and the remaining portion thereof protruded from an end face of the anode body. One hundred and six anode sections were formed and aligned at regular intervals, and the anode leads were welded to a long and narrow plate-shaped first electrode.

### (ii) Formation of Dielectric Layer

The anode section with the anode lead welded to the first electrode was immersed, together with a portion of the anode lead, in a chemical conversion solution within a chemical conversion bath entirely made of glass, and a second electrode made of Ta was immersed in the chemical conversion solution. In this state, a DC voltage was applied between the first electrode and the second electrode, to oxidize the surface of the anode body and form a dielectric layer. For the chemical conversion solution, a 0.06 mass % aqueous nitric acid solution was used. The temperature of the chemical conversion solution was 60° C. The DC voltage was 15 V, which was applied for 10 hours. The chemical conversion was followed by drying at 100° C. for 10 minutes. In this way, a uniform chemical conversion film (thickness approx. 30 nm) of tantalum oxide (Ta₂O₅) was formed as a dielectric layer on the surface of the anode body and on the surface of the portion of the anode lead.

(iii) Formation of Solid Electrolyte Layer

A mixed solution was prepared by dissolving 3,4-ethylenedioxythiophene and polystyrene sulfonic acid in ion-exchanged water. To the mixed solution, under stirring, iron(III) sulfate (oxidizing agent) dissolved in ion-exchanged water was added, to allow a polymerization reaction to proceed. After the reaction, the resultant reaction solution was dialyzed, to remove unreacted monomers and excess oxidizing agent. A predetermined amount of water was removed from the resultant mixture, and then, isopropanol was added to the mixture, to obtain a liquid dispersion containing polyethylenedioxythiophene doped with polystyrenesulfonic acid (PEDOT/PSS).

The anode body with the dielectric layer formed thereon was impregnated with the liquid dispersion for 5 minutes, and then dried at 150° C. for 30 minutes, to form a solid electrolyte layer on the dielectric layer. Next, the anode body with the solid electrolyte layer formed thereon was washed using isopropanol as a washing liquid, and dried at 150° C. for 30 minutes.

### (iv) Formation of Carbon Layer

A dispersion liquid (carbon paste) of carbon particles dispersed in water was applied onto the solid electrolyte layer, followed by heating at 200° C., to form a carbon layer on the surface of the solid electrolyte layer.

### (v) Formation of Metal Particle-Containing Layer

A silver paste containing silver particles, a binder resin, and a solvent was applied onto the surface of the carbon layer. This was followed by heating at 200° C., to form a metal particle-containing layer. Thus, a capacitor element was obtained.

### (2) Production of Solid Electrolytic Capacitor

A conductive adhesive was applied onto the metal particle-containing layer of the capacitor element, and the cathode lead terminal was joined to the metal particle-containing layer. The anode lead and the anode lead terminal were joined to each other by resistance welding. Next, the capacitor element with the lead terminals joined thereto was placed in a mold, and encapsulated with a material of a package body (thermosetting resin composition) by transfer molding. In this way, a solid electrolytic capacitor A1 with a rated voltage Rv of 16 V and a rated capacity Rc of 150 μF was produced. The value of the right side of the inequation (I) is 0.176×(Rv×Rc)−90=332.4.

### Example 2

A solid electrolytic capacitor A2 was produced in the same manner as in Example 1, except that in (1) (iii) of Example 1, as the washing liquid, a mixed solvent of isopropanol and distilled water mixed in a mass ratio of 60:40 was used.

### Example 3

A solid electrolytic capacitor A3 was produced in the same manner as in Example 1, except that in (1) (iii) of Example 1, as the washing liquid, a solution of isopropanol and an aqueous sulfuric acid solution (sulfuric acid concentration: 1 mass %) mixed in a mass ratio of 60:40 was used for washing.

### Example 4

In (1) (ii) of Example 1, the anode body with the dried dielectric layer formed thereon after drying was washed with a washing liquid having the same composition as that in Example 3, and further dried at 100° C. for 10 minutes. Except for this, in the same manner as in Example 1, a solid electrolytic capacitor A4 was produced.

### Example 5

In (1) (ii) of Example 1, after the chemical conversion and before drying the anode body taken out from the chemical formation solution, the anode was washed with a washing liquid having the same composition as that in Example 3, and dried at 100° C. for 10 minutes. Except for this, in the same manner as in Example 1, a solid electrolytic capacitor A5 was produced.

### Comparative Example 1

A solid electrolytic capacitor B1 was produced in the same manner as in Example 1, except that in (1) (iii) of Example 1, as the washing liquid, distilled water was used.

### <<Evaluation>>

The solid electrolytic capacitors obtained in Examples and Comparative Examples were dried at 170° C. for 3 hours, and then, cooled to 25° C.±5° C. in a drying chamber. The solid electrolytic capacitors in this state were subjected to the following evaluations.

(1) Measurement of Iₘ and Iᵢ

In the air, at 25° C.±5° C., a voltage was applied to each of the solid electrolytic capacitors, to raise the voltage of the solid electrolytic capacitor from 0 V to Rv in a time of 30±5 msec. The maximum current value (unit: mA) that flowed at this time was determined. Also, the current value (unit: mA) 5 msec. after the start of the above voltage application was determined. For the above maximum current value of the solid electrolyte capacitor of each Example, an average value Iₘ of 20 results was calculated. For the current value 5 msec. after the start of the voltage application, an average value Iᵢ of 20 results was calculated. From these values, the ratio Iₘ/Iᵢ was calculated.

(2) Measurement of Iₙ and Iₚ

In the air, at 25° C.±5° C., the rated voltage Rv was applied to the solid electrolytic capacitor, and the leakage current value that flowed after 10 msec. was measured. An average value Iₙ of 20 results was calculated.

In the air, at 25° C.±5° C., the rated voltage Rv was applied to the solid electrolytic capacitor, and the leakage current value that flowed after 1.3 msec. was measured. An average value Iₚ of 20 results was calculated.

### (3) Measurement of ACC

The ACC (unit: mA) of the solid electrolytic capacitor of each Example was measured in the procedures as described above, and an average value of 20 results was calculated.

The Iₚ value of the solid electrolytic capacitor of each Example was taken as “x”, and the ACC (average value) was taken as “y”, and the “y” was plotted against the “x”, to obtain an approximate expression (linear expression) and a determination coefficient R² of the linear expression.

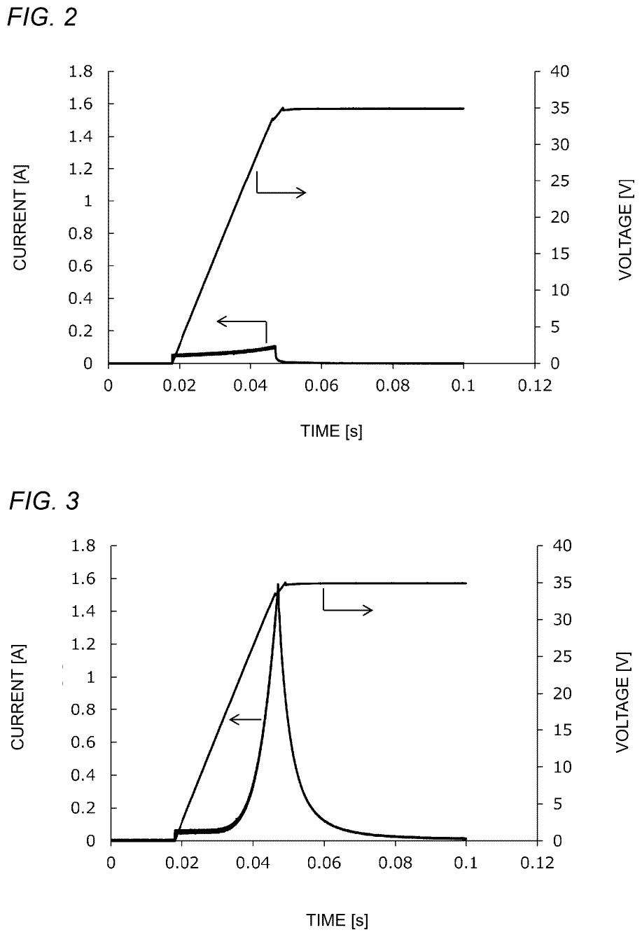

The evaluation results of (1) and (2) above are shown in Table 1. In Table 1, A1 to A4 are of Examples 1 to 4, respectively, and B1 is of Comparative Example 1. The changes of leakage current with changes over time during voltage application in the solid electrolytic capacitor of Example 1 are shown in FIG. 2. The changes of leakage current with changes over time during voltage application in the solid electrolytic capacitor of Comparative Example 1 are shown in FIG. 3.

TABLE 1

| | Iₘ (mA) | Iₘ/Iᵢ | Iₙ (mA) |
|---|---|---|---|
| A1 | 304 | 4.11 | 66 |
| A2 | 187 | 2.53 | 34 |
| A3 | 81 | 1.10 | 13 |
| A4 | 80 | 1.08 | 11 |
| B1 | 1201 | 16.21 | 980 |

As shown in Table 1 and FIG. 3, in Comparative Example B1 corresponding to the conventional example, a large current (maximum current value Iₘ) flowed in the stage after a very short time from the start of the voltage application, and the Iₘ/Iᵢ far exceeded 10. In addition, the leakage current value Iₙ when the rated voltage Rv was applied also far exceeded 100 mA. If a large current flows in association with voltage application, a malfunction tends to be induced in the electronic circuit to which the solid electrolytic capacitor is connected. In contrast, in Examples A1 to A4, even in the stage after a very short time from the start of the voltage application, the maximum current value Iₘ was small, and the ratio Iₘ/Iᵢ was 10 or less (preferably 5 or less, 3 or less, or 2 or less) (for A1, see FIG. 2). The leakage current value Iₙ was also as small as 100 mA or less. Therefore, in Examples A1 to A4, the malfunction that occurs when the solid electrolytic capacitor is used by being connected to an electronic circuit can be suppressed.

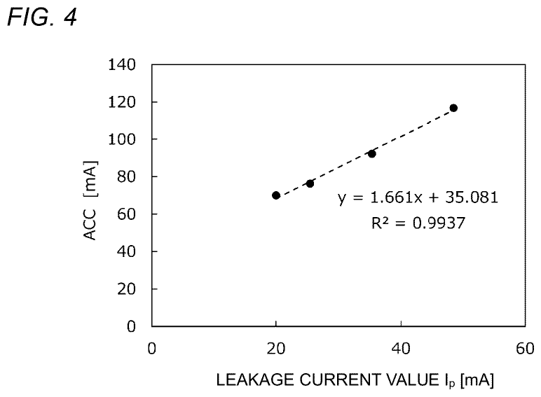

For A1 to A4, a graph obtained by plotting the leakage current value Iₚ (mA) taken as “x” and the ACC (mA) taken as “y” is shown in FIG. 4. As shown in FIG. 4, in A1 to A4, the ACC (=y) was expressed by a linear expression: y=1.661x+35.081 of the leakage current value Iₚ (=x). Furthermore, R2, which indicates the reliability of the above linear expression, was 0.9937. It can be said that in such a solid electrolytic capacitor, the maximum current value Iₘ is controlled to be small, and even when used by being connected to an electronic circuit, the solid electrolytic capacitor will cause no adverse effect such as malfunction.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The solid electrolytic capacitor of the present disclosure, in which the leakage current that flows in an early stage during the voltage application is low, has high reliability. Therefore, the solid electrolytic capacitor is suitable for applications in which it is used by being connected to an electronic circuit, and in such applications, the malfunction of the electronic circuit can be suppressed. The applications of the solid electrolytic capacitor, however, are not limited only to them.

### REFERENCE SIGNS LIST

100: electrolytic capacitor
110: capacitor element
111: anode section
112: anode lead
113: anode body
113e1: first end face
113e2: second end face
113G: anode body group
113s: side face
114: dielectric layer
115: cathode section
116: solid electrolyte layer
117: cathode-leading layer
120: anode lead terminal
121: anode terminal portion
122: lead connection portion
130: cathode lead terminal
131: cathode terminal portion
132: connection portion
141: conductive layer

1. A solid electrolytic capacitor, comprising
at least one capacitor element, wherein
the capacitor element includes an anode body, a dielectric layer covering at least part of the anode body, and a solid electrolyte covering at least part of the dielectric layer,
a rated voltage of the solid electrolytic capacitor is Rv (unit: V), and
a maximum current value Iₘ (unit: mA) that flows when a voltage is applied at 25° C.±5° C. after the solid electrolytic capacitor is dried at 170° C. for 3 hours, to raise a voltage of the solid electrolytic capacitor from 0 V to Rv in a time of 30±5 msec., and a current value Iᵢ (unit: mA) 5 msec. after a start of the voltage application satisfy Iₘ/Iᵢ≤10.

2. The solid electrolytic capacitor according to claim 1, wherein
a rated capacity of the solid electrolytic capacitor is Rc (unit: μF), and
the maximum current value Iₘ satisfies a following inequation (I):
$${I}_{m} \leq 0.176 \times ( Rv \times Rc ) - 90. \qquad ( I )$$

3. The solid electrolytic capacitor according to claim 1, wherein the maximum current value Iₘ and the current value Iᵢ satisfy Iₘ/Iᵢ≤3.

4. A solid electrolytic capacitor, comprising
at least one capacitor element, wherein
the capacitor element includes an anode body, a dielectric layer covering at least part of the anode body, and a solid electrolyte covering at least part of the dielectric layer,
a rated voltage of the solid electrolytic capacitor is Rv (unit: V), and
a leakage current value Iₙ that flows 10 msec. after the rated voltage Rv is applied at 25° C. 5° C. after the solid electrolytic capacitor is dried at 170° C. for 3 hours is 100 mA or less.

5. The solid electrolytic capacitor according to claim 1, wherein when a leakage current value Iₚ (unit: mA) that flows 1.3 msec. after the rated voltage Rv is applied at 25° C.±5° C. after the solid electrolytic capacitor is dried at 170° C. for 3 hours is plotted against an anomalous charging current (unit: mA), the leakage current value Iₚ and the anomalous charging current are approximated by a linear expression.

6. The solid electrolytic capacitor according to claim 5, wherein a determination coefficient R² of the linear expression is 0.9 or more.

7. The solid electrolytic capacitor according to claim 2, wherein when a leakage current value Iₚ (unit: mA) that flows 1.3 msec. after the rated voltage Rv is applied at 25° C.±5° C. after the solid electrolytic capacitor is dried at 170° C. for 3 hours is plotted against an anomalous charging current (unit: mA), the leakage current value Iₚ and the anomalous charging current are approximated by a linear expression.

8. The solid electrolytic capacitor according to claim 7, wherein a determination coefficient R² of the linear expression is 0.9 or more.

9. The solid electrolytic capacitor according to claim 4, wherein when a leakage current value Iₚ (unit: mA) that flows 1.3 msec. after the rated voltage Rv is applied at 25° C.±5° C. after the solid electrolytic capacitor is dried at 170° C. for 3 hours is plotted against an anomalous charging current (unit: mA), the leakage current value Iₚ and the anomalous charging current are approximated by a linear expression.

10. The solid electrolytic capacitor according to claim 9, wherein a determination coefficient R² of the linear expression is 0.9 or more.

11. The solid electrolytic capacitor according to claim 2, wherein the maximum current value Iₘ and the current value Iᵢ satisfy Iₘ/Iᵢ≤3.
